(19) United States
(12) Patent Application Publication
(10) Pub. No.: US 2021/0161133 A1
(43) Pub. Date: Jun. 3, 2021

(54) COMBINATIONS OF ORGANIC COMPOUNDS TO INCREASE CROP PRODUCTION

(71) Applicant: PLANT SENSORY SYSTEMS LLC, Baltimore, MD (US)

(72) Inventors: Frank J. TURANO, Baltimore, MD (US); Kathleen A. TURANO, Baltimore, MD (US)

(73) Assignee: PLANT SENSORY SYSTEMS LLC, Baltimore, MD (US)

(21) Appl. No.: 17/053,247

(22) PCT Filed: May 7, 2018
(86) PCT No.: PCT/US18/31359

§ 371 Date: Nov. 5, 2020

(51) Int. Cl. A01N 37/44; A01N 59/16; A01N 59/02; A01N 59/14; A01N 41/08

(52) U.S. Cl. CPC A01N 37/44; A01N 59/16; A01N 41/08; A01N 59/14; A01N 59/02

(57) ABSTRACT

The present invention provides formulations using combinations of protein alpha-amino acids, non-protein alpha-amino acids, beta-amino acids, gamma-amino acids, methyl-amino acids, polyamines or sulfonic acids, to increase plant growth or improve agronomic quality. The present invention provides for use of the formulations as a foliar spray, soil additive, or plant-organ or seed treatment. The present invention provides applications of the formulation to plants, plant organs or seeds to enhance plant performance, especially with regard to promotion of germination, growth, yield or increased sugar content or total sugar production. The present invention describes methods, compositions and uses for different ratios of protein alpha-amino acids, non-protein alpha-amino acids, beta-amino acids, gamma-amino acids, methyl-amino acids, polyamines, or sulfonic acids together optionally with or without essential nutrients including micronutrients and macronutrients, carbon source or surfactants to plants, plant organs or seeds to increase plant production or sugar production.

### FIELD OF THE INVENTION

The present invention relates to formulations and uses of nitrogen—(N) or sulfur—(S) containing organic compounds that increase plant growth, yield or sugar content. The present invention particularly relates to mixtures of N- or S-containing organic compounds from the general groups of molecules including protein alpha-amino acids, non-protein alpha-amino acids, beta-amino acids, gamma-amino acids, methyl-amino acids, polyamines or sulfonic acids in effective amounts to increase plant growth, yield or sugar production. The present invention also relates to mixtures of N- or S-containing organic compounds with or without the addition of macronutrients, micronutrients, sugars, organic acids, protein hydrolysates, humic or fulvic acids in effective amounts to increase plant growth, yield or sugar production. The present invention relates to applying the formulation as a foliar spray, soil drench, or seed treatment.

### BACKGROUND

Fertilizers Increase Production and Yield

Plants capture solar energy and produce soluble carbohydrates or sugars through the process of photosynthesis. Sugars are used as building blocks for other molecules to increase growth and yield. Sugars can be metabolized in the cell, stored or translocated out of the cell and transported to different parts of the plant where they can be metabolized or stored. The distribution and accumulation of sugars in plant cells and in specific plant organs are a result of a combination of processes that include increased photosynthesis, translocation and storage, and decreased breakdown or catabolism.

The current teaching in the art focuses on the maximization of these processes by increasing the overall health and growth of the plant through the use of traditional inorganic fertilizers (1-4). Fertilizers provide the necessary nutrients to maintain the health and growth of plants and to maximize productivity and yields. Most fertilizers maximize the ratio of the major nutrients or macronutrients, which are N, phosphorus (P), and potassium (K), and contain calcium (Ca), magnesium (Mg), and S, which are required for plant growth and development. In addition, fertilizers often contain other elements that are required by plants in low concentrations or amounts including the micronutrients, boron (B), copper (Cu), iron (Fe), chloride (Cl), manganese (Mn), molybdenum (Mo) and zinc (Zn). Fertilizers can be applied to the soil or to the leaves as a foliar application with the goals of increasing plant productivity, health and yield by increasing fruit number or size, seed production, sugar production, or biomass through increased leaf, petiole, bud, bulb, root, fruit or seed size.

Complex interactions between carbon (C), N and S metabolism are known to exist in plants (5, 6) at the cellular and Whole plant levels (7) and can alter nutrient partitioning. The partitioning of C, N and S in the plant is also affected by other plant macronutrients such as K and Pas well as the micronutrients Fe, Zn, Mn, Mo, and B, There are general descriptions of using sources of N, S or C either with or without macronutrients and micronutrients (8, 9) to maximize plant growth, yield, germination and early seedling development. N is required for plant health and growth, but N in the form of ammonium, nitrate or urea decreases sugar content in plants (10). It is common practice in the sugar industry to apply N-based fertilizers, such as urea, ammonium sulfate, mono-ammonium phosphate (MAP), urea ammonium, or nitrate, early in the growing season to sugar beet or sugar cane crops to promote growth. However, N-based fertilizers are not applied near harvest time because their addition decreases the sugar content in the plants and increases the amount of impurities in the extracted sugars. The flow of C into sucrose and starch increases in plants in low N conditions (11-13). There are instances when it is desirable to increase metabolism to promote growth and sugars. Yet, little information is available on how to formulate a fertilizer with N-, C-, or S-containing compounds to increase biomass or yield and increase sugar concentrations in plant organs. This invention relates to the use of a mixture of N- or S-containing organic compounds with or without macronutrients, micronutrients, sugars, organic acids or humic substances to promote plant growth, yield or sugar production in plants or plant organs.

Groups of N- or S-Containing Organic Compounds

Whereas the application of inorganic N and S to plants generally increases yield (8, 9), those of ordinary skill in the art know that the application of N- or S-containing organic compounds promotes specific processes such as root growth, root hair growth, root architecture, photosynthetic capacity and tolerance to biotic and abiotic stresses. The N- or S-containing organic compounds can be classified into groups: protein alpha-amino acids (i.e., alpha-amino acids found in proteins), non-protein alpha-amino acids, beta-amino acids, gamma-amino acids, methyl-amino acids, polyamines or sulfonic acids. Table 1 provides a list of the groups of the N- or S-containing organic compounds, references on the agronomic benefits associated with the group, a representative molecule of each group and its structure.

TABLE 1
Groups of N- or S-containing organic compounds.

| | Refer- | | |
|---|---|---|---|
| | ences | | |
| | for | | |
| | Agro- | Repre- | Structure of |
| | nomic | sentative | Representative |
| Group | Benefits | Molecule | Molecule |
| Protein alpha- amino acids | (14-16) | Leucine (Leu) | 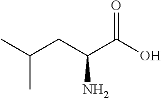 |
| Non- protein alpha- amino acids | (17) | Ornithine (Orn) | 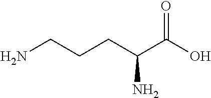 |
| Beta- amino acids | (18-21) | β-amino- butyric acid (BABA) | 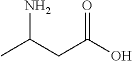 |
| Gamma- amino acids | (21, 22) | γ-amino- butyric acid (GABA) | 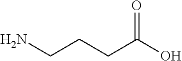 |
| Methyl amino acids | (23) | Sarcosine (Sar) | 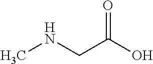 |
| Poly- amines | (24-27) | Putrescine (Put) | 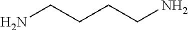 |
| Sulfonic acids | (28) | Taurine (Tau) | 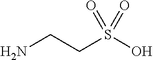 |

Current State of the Art

A description of the current state of the art is summarized in the sections below. In general, an individual compound or mixes of compounds within a group of N- or S-containing organic compounds (e.g., mixes of protein alpha-amino acids) have been shown to increase plant productivity or provide agronomic benefits. In the present invention, we teach that combining compounds from two or more groups of N- or S-containing organic compounds further increases plant productivity and growth. In the sections below are the few reports on the use of a combination of compounds from two different groups of N- or S-containing organic compounds and their agronomic benefits. The sections below also state how the present invention differs from what is currently known and what is unique to this invention.

Protein Alpha-Amino Acids

The application of protein alpha-amino acids on plants to promote plant growth or changes in the growth patterns of specific plant organs was first reported in the 1950s. Fertilizers containing the protein alpha-amino acids, aspartate (29), glutamate (29), arginine (29-31), and lysine (30), were reported to enhance root growth. More recent studies have shown that the use of protein alpha-amino acids as fertilizers can promote mycorrhiza development (32), alter metabolism, plant defense responses, anti-oxidation responses (33) and increase tolerance to biotic and abiotic stresses (14-16). Dickinson et al. (34) teach the production and use of chelated alpha-amino acids as fertilizers. Svec and Vidyarthi (35) teach compositions and uses of fertilizer derived from mixes of amino acids, carbohydrates and polysaccharides to increase plant production. The amino acids can be alanine, arginine, aspartate, cysteine, glutamate, glycine, histidine, isoleucine, leucine, lysine, methionine, phenylalanine, proline, serine, threonine, tryptophan, tyrosine, or valine, and the carbohydrates and polysaccharides can be alginic acid, mannitol, laminarin, succinic acid, sorbitol, fructose, sucrose, dextrose, or lactose. Smith et al. (36) teach compositions and uses of fertilizer derived from mixes of amino acids, carbohydrates and polysaccharides to increase plant production. The fertilizer is composed or proline, hydroxyproline, tryptophan, glycolic acid, and at least one additional compound that can be either an amino acid from the list of arginine, glutamate, alanine, cysteine, lysine, serine, or tryptophan or a compound from the list of acetaminophen, caffeine, anthranilic acid, betaine, choline bitartrate, salicylic acid, sorbitol, succinic acid or calcium EDTA chelate. Nonomura and Benson (37) teach formulations and uses of protein alpha-amino acids, preferably glycine, glutamate, glutamine, alanine and aspartate, with methanol, ethanol, propanol, butanol, formaldehyde, formic acid, or methyl formate. Nothing has been reported or taught on the use of protein alpha-amino acids in combination with other N- or S-containing organic compounds including beta-amino acids, methyl-amino acids, polyamines or sulfonic acids, to promote plant growth, yield or sugar content.

Protein hydrolysates are different from the pure protein alpha-amino acids in that they contain a mix of several protein alpha-amino acids. Application of protein hydrolysates has been shown to promote root growth (30) and shoot growth (38, 39). Makarov (40) teaches that protein hydrolysates can stimulate calli rooting and plant growth. Nothing has been reported or taught on the use of protein hydrolysates in combination with members of other N- or S-containing organic compounds including non-protein alpha-amino acids, beta-amino acids, gamma-amino acids, methyl-amino acids, polyamines or sulfonic acids, to promote plant growth, yield or sugar content.

Näsholm and Öhlund (41) teach the formulation and uses of fertilizers composed of the basic protein alpha-amino acids: arginine, lysine and histidine. Näsholm and Svennerstam (32) teach that an L-amino acid (protein alpha-amino acid) combined with a N-containing inorganic compound promotes the growth of both roots and beneficial fungi mycorrhiza. Näsholm and Öhlund (42) teach that a fertilizer with basic amino acids linked to an immobile N substrate promotes growth of trees. The patents teach the combination of a protein alpha-amino acid with an inorganic N source to promote plant growth. None of the patents teach the combination of a protein alpha-amino acid with members of other groups of N- or S-containing organic compounds including organic acids, non-protein alpha-amino acids, beta-amino acids, gamma-amino acids, methyl-amino acids, polyamines or sulfonic acids, to promote plant growth, yield or sugar content.

Non Protein Alpha Amino Acids

Approximately 250 non-protein alpha-amino acids can be found in plants (reviewed in (17) and references therein). Early studies demonstrated that the non-protein alpha-amino acids, citrulline and ornithine, changed plant root growth responses (30), and ornithine has been shown to also provide tolerance to salt stress (43). There are no reports on the effects of the non-protein alpha-amino acids including homoserine, phosphoserine, homoarginine, arginosuccinic acid, S-adenosylmethionine, and homocysteine to increase plant growth, yield or sugar content In addition, there are no reports on the combined use of non-protein alpha-amino acids with members of other groups of N- or S-containing organic compounds including organic acids, beta-amino acids, gamma-amino acids, methyl-amino acids, polyamines or sulfonic acids, to increase plant growth, yield or sugar content.

Beta-Amino Acids

Beta-amino acids include beta-aminobutyric acid (BABA), beta-aminovaleric acid, beta-alanine, beta-aminoisobutvric acid, beta-homoserine or aminolevulinic acid. The first reports of using BABA on plants was in 1958 when it was demonstrated that plants treated with BABA had increased levels of pathogenesis-related (PR) proteins (44). PR-proteins are part of the systemic acquired resistance response of plants to pathogens. Later studies showed that BABA applied as a root drench provided plants with increased tolerance to biotic stress (45). BABA was shown to also increase tolerance to abiotic stress in studies where BABA was applied as a foliar spray (18) or when seeds were imbibed (seed priming) in BABA solutions (46). A review of plant responses to BABA can be found in (1 8-21) and references therein.

Cohen (47) teaches that BABA or beta-aminovaleric acid can be applied to plants to protect them from bacterial and fungal infection. The patent does not teach the combined use of beta-amino acids with members of the following classes of molecules: sugars, organic acids, protein alpha-amino acids, non-protein alpha-amino acids, gamma-amino acids, methyl-amino acids, polyamines or sulfonic acids to promote plant growth, yield, or sugar content.

Gamma-amino acids

The first reports of the beneficial growth effects of exogenous applications of gamma-aminobutyric acid (GABA) to plants were by Kinnersley (48). Since then several studies have reported positive effects of exogenous GABA on plants including increased growth and development (49-51), tolerance to abiotic stresses (52-63), accumulation of organic and amino acids and sugars (61), improved photosynthesis (51, 64) and nitrogen metabolism (51). GABA applied to leaves increases the accumulation of amino acids, organic acids, sugars (sucrose, fructose, glucose, galactose, maltose), and sugar alcohols, and the response is magnified with exposure to high temperature (61). For a review of the effects of GABA on plants see (21, 22) and references therein.

Khmersley et al. (48) teach that GABA can be used alone or combined with the specific organic acids citric acid, malic acid, succinic acid, or fumaric acid, and/or the specific amino acid glutamate, and/or the specific simple carbohydrates sucrose and glucose. Kinnerslev et al. (65) teach that GABA can be combined with glutamate, a source of proteinaceous amino acids, and a C skeleton and used as a fertilizer to increase fertilizer efficiency, plant productivity, growth, and nutrient accumulation. The patent specifies that the sources of proteinaceous amino acids include protein hydrolysates, (such as casein hydrolysate), blood fermentation media, blood peptone fermentation media, blood protein fermentation media, cotton seed fermentation media, and corn steep liquor. The patent specifies that the C skeletons include glucose, sucrose, or glucose and succinic acid. Apart from the above-mentioned compounds, no other reports exist on the combined use of gamma-amino acids with members of other groups of N- or S-containing organic compounds including organic acids, protein alpha-amino acids, non-protein alpha-amino acids, beta-amino acids, methyl-amino acids, polyamines or sulfonic acids, to promote plant growth, yield or sugar content. No report exists on the use of other gamma amino acids on plants including but not limited to 4-aminovaleric acid or 5-aminovaleric acid.

Methyl Amino Acids

Johnson and Peel (2:) teach that methyl-amino acids, specifically sarcosine, mixed with fertilizer or kelp extracts increase plant growth and development. N-methyl-glycine (sarcosine) is an intermediate in glycine metabolism and catabolism. No other methyl amino acids has been reported to promote plant growth, yield or sugar content including but not limited to N,N-dimethylglycine, N-methyl-L-alanine or N-methyl-L-leucine. No report exists on the combined use of methyl-amino acids with members of other groups of N- or S-containing organic compounds including sugars, organic acids, protein alpha-amino acids, non-protein alpha-amino acids, beta-amino acids, gamma-amino acids, polyamines or sulfonic acids, to promote plant growth, yield or sugar content.

Polyamines

Polyamines, including the diamines—putrescine and cadaverine, the triamine—spermidine, and the tetraamine—spermine, have been reported to function as antioxidants to protect plants from the oxidative effects of salt, drought, low temperature, and ozone exposure (66). Polyamines have been also linked to increased cell division and membrane stabilization in plants. Exogenous applications of polyamines improve photosynthetic capacity, increase tolerance to salt, cold and heat and biotic stressors as well as promote root and flower development, delay senescence of fruit, and increase mycorrhizal colonization (reviewed in (24-27) and references therein). No report exists on the combined use of polyamines with members of other groups of N- or S-containing organic compounds including sugars, organic acids, protein alpha-amino acids, non-protein alpha-amino acids, beta-amino acids, gamma-amino acids, methyl-amino acids or sulfonic acids, to promote plant growth, yield or sugar content.

Sulfonic Acids

Exogenous applications of the sulfonic acid, 2-amino ethanesulfonic acid (taurine: Tau), increases photosynthetic capacity, plant productivity and yield (28). Suzuki et al. (28) teach that exogenous application of Tau increases crop harvest. Applications of Tau by foliar spray, soil and root drench or seed immersion increased crop production, yield, seedling growth and photosynthetic capacity of isolated plant cells (protoplasts and chloroplasts). No report exists on the use of other sulfonic acids to promote plant growth, yield or sugar content including but not limited to methylsulfamic acid, sulfoacetic acid hypotaurine, formamidinesulfinic acid, hydroxylamine-O-sulfonic acid, allylsulfonate, sodium 3-mercapto-1-propanesulfonate, sodium 2,3-dimercaptopropanesulfonate monohydrate, 1-propanesulfonic acid, 3-hydroxypropane-1-sulfonic acid, 1,3-propanedisulfonic acid, 3-hydroxypropane-1-sulfonic acid or 3-amino-1-propanesulfonic acid on plants. No report exists on the combined use of sulfonic acids with members of other groups of N- or S-containing organic compounds including sugars, organic acids, protein alpha-amino acids, non-protein alpha-amino acids, beta-amino acids, gamma-amino acids, methyl-amino acids, or polyamines, to promote plant growth, yield or sugar content.

Sugars

Sugars have been shown to stimulate plant growth and production and provide protection against oxidative stress and pathogens (reviewed in (67, 68)). Yamashita (69, 70) teaches formulations and uses of fertilizers containing molasses or sugars with micro- and macro-nutrients to promote plant productivity. The sugars can be mannose, lactose, dextrose, erythrose, fructose, fructose, galactose, glucose, gulose, maltose, raffinose, ribose, ribulose, rutinose, saccharose, stachyose, trehalose, xylose, xylulose, amylose, arabinose, fructose phosphate, adonitol, galactitol, maltitol, mannitol, ribitol, sorbitol, or mixtures of these compounds. No report exists on the combined use of sugars with members of other groups of N- or S-containing organic compounds including non-protein alpha-amino acids, beta-amino acids, methyl-amino acids, polyamines, or sulfonic acids to promote plant growth, yield or sugar content.

Organic Acids

Organic acids or organic carboxylic acids have been shown to promote plant growth and development. For a review of the beneficial roles of organic acids in plants see (71, 72). Talehi et at. (73) observed a significant increase in plant height and peduncle length were significantly in plants treated with a foliar application of citric acid or malic acid compare with untreated control plants. Binder et al. (74) teach compositions and uses of fertilizers with high N to C ratios. Binder discloses the use of carboxylic acids (organic acids) including lactic acid, citric acid, formic acid, acetic acid, propionic acid, butanoic acid, oxalic acid, malic acid, succinic acid, furnaric acid, ascorbic acid, or tartaric acid combined with protein alpha-amino acids, preferentially glycine, alanine, serine, valine, lysine, asparagine, glutamine, histidine, arginine, methionine, or threonine. No report exists on the combined use of organic acids with members of other groups of N- or S-containing organic compounds including non-protein alpha-amino acids, beta-amino acids, methyl-amino acids, polyamines or sulfonic acids to promote plant growth, yield or sugar content.

Humic Substances

Humic substances, such as humic and fulvic acids, have been shown to stimulate plant growth and production. For a review, see (75, 76) and references therein. Humic acid may promote plant growth through the induction of C and N metabolism. Robinson (77) teaches compositions and uses of fertilizer with humic acid. Kitten (78) teaches compositions and uses of fertilizer with humic acid in combination with N, P, calcium and B. Porubcan (79) teaches compositions and uses of fertilizer with humic acid. Yamashita (80, 81) teaches compositions and uses of fertilizer with humic acid or fulvic: acid and at least one coenzyme including vitamin B, folic acid or pyridoxine. Taganov et al. (82) teach compositions and uses of fertilizer with fulvic acid. Wells (83, 84) teaches compositions and uses of foliar fertilizer with fulvic acid mixed with macro- and micro-nutrients. No report exists on the combined use of humic substances with members of other groups of N- or S-containing including non-protein alpha-amino acids, beta-amino acids, methyl-amino acids, polyamines or sulfonic acids to promote plant growth, yield or sugar content.

In all the referenced cases, the promotive effects were reported from the application of N- or S-containing organic compounds. Little is known about the benefits of applying combinations of the N- or S-containing organic compounds or about the effective levels of concentrations required to increase plant productivity or quality. Lacking in the literature are detailed reports or teachings of the use of protein alpha-amino acids combined with other N- or S-containing organic molecules such as a non-protein alpha-amino acid, beta-amino acid, gamma-amino acid, methyl-amino acid, polyamine or sulfonic acid with or without other organic acids (acetic acid, butyric acid, caproic acid, citric acid, formic acid, fumaric acid, lactic acid, malic acid, oxalic acid, propionic acid, or succinic acid, or their salt form) or sugars.

### DESCRIPTION OF THE INVENTION

The present invention provides methods of developing a formulation for a fertilizer, fertilizer additive, or growth enhancer to increase plant growth or improve agronomic quality that comprises a mixture of molecules that contains at least one molecule from two of the following groups: protein alpha-amino acids, non-protein alpha-amino acids, beta-amino acids, gamma-amino acids, methyl-amino acids, polyamines, or sulfonic acids. The present invention also provides for methods of developing the said formulation for a fertilizer, fertilizer additive, or growth enhancer with macronutrients, micronutrients, sugars, organic acids, protein hydrolysates, humic acid, fulvic acid or surfactants. The present invention provides for use of the formulations as a foliar spray, fertilizer additive, soil additive, root soak, drench, liquid chemical irrigation, soil injection, liquid chemical dripping, seed treatment or seed priming. The present invention provides applications of the formulation to plants, plant organs or seeds to enhance plant performance, especially with regard to promotion of germination, growth, yield or increased sugar content or total sugar production. The present invention describes methods, compositions and uses for different ratios of protein alpha-amino acids, non-protein alpha-amino acids, beta-amino acids, gamma-amino acids, methyl-amino acids, polyamines, or sulfonic acids together optionally with or without essential nutrients including micronutrients and macronutrients, carbon (C) source or surfactants to plants, plant organs or seeds to increase plant production or sugar production.

The invention may be applied to a wide variety of plants, angiosperm and gymnosperm, including bushes, tress, decorative or recreational plants or crops, but are particularly useful for treating commercial and ornamental crops. Examples of plants that can be used with the present invention include, but are not limited to, Acacia, alfalfa, almond, aneth, apple, apricot, artichoke, arugula, asparagus, avocado, banana, barley, beans, beech, beet, Bermuda grass, bent grass, blackberry, blueberry, Blue grass, broccoli, Brussels sprouts, cabbage, camelina, cannabis, canola, cantaloupe, carinata, carrot, cassava, cauliflower, celery, cherry, chicory, cilantro, citrus, clementine, coffee, corn, cotton, cucumber, duckweed, Douglas fir, eggplant, endive, escarole, eucalyptus, fennel, fescue, figs, forest trees, garlic, gourd, grape, grapefruit, honey dew, jicama, kiwifruit, lettuce, leeks, lemon, lime, Loblolly pine, maize, mango, melon, mushroom, nectarine, nut, oat, okra, onion, orange, an ornamental plant, palm, papaya, parsley, pea, peach, peanut, pear, pepper, persimmon, pine, pineapple, plantain, plum, pomegranate, poplar, potato, pumpkin, quince, radiata pine, radicchio, radish, rapeseed, raspberry, rice, rye, rye grass, seaweed, scallion, sorghum, Southern pine, soybean, spinach, squash, strawberry, sudangrass, sugar beet, sugarcane, sunflower, sweet potato, sweetgum, Swiss chard, switchgrass, tangerine, tea, tobacco, tomato, triticale, turf, turnip, a vine, watermelon, wheat, yams, and zucchini.

For purposes of promoting an understanding of the principles of the invention, reference will now be made to particular embodiments of the invention and specific language will be used to describe the same. The materials, methods and examples are illustrative only and not limiting. Unless mentioned otherwise, the techniques employed or contemplated herein are standard methodologies well known to one of ordinary skill in the art. Specific terms, while employed below, are used in a descriptive sense only and not for purposes of limitation. The practice of the present invention will employ, unless otherwise indicated, conventional techniques of botany, plant science, horticulture, and agriculture that are within the skill of the art.

One embodiment of the present invention provides a method of using a foliar spray or application that comprises a mixture of molecules that contains at least one molecule from at least two of the following groups: protein alpha-amino acids, non-protein alpha-amino acids, beta-amino acids, gamma-amino acids, methyl-amino acids, polyamines, or sulfonic acids to increase yield, biomass or sugar production. The present invention also provides for methods of the said foliar spray or application to contain macronutrients, micronutrients, sugars, organic acids, protein hydrolysates, humic acid, fulvic acid or surfactants.

Another embodiment of the present invention provides a method of using a soil or root drench that comprises a mixture of molecules that contains at least one molecule from at least two of the following groups: protein alpha-amino acids, non-protein alpha-amino acids, beta-amino acids, gamma-amino acids, methyl-amino acids, polyamines, or sulfonic acids to increase yield, biomass or sugar production. The present invention also provides for methods of the said soil or root drench to also contain macronutrients, micronutrients, sugars, organic acids, protein hydrolysates, humic acid, fulvic acid or surfactants.

Another embodiment of the present invention provides a method of using a seed treatment or seed priming solution that comprises a mixture of molecules that contains at least one molecule from at least two of the following groups: protein alpha-amino acids, non-protein alpha-amino acids, beta-amino acids, gamma-amino acids, methyl-amino acids, polyamines, or sulfonic acids to increase yield, biomass or sugar production. The present invention also provides for methods of the said seed treatment or seed priming solution to also contain macronutrients, micronutrients, sugars, organic acids, protein hydrolysates, humic acid, fulvic acid or surfactants.

Another embodiment of the present invention is the use of a mixture of molecules that contains at least one molecule from at least two of the following groups: protein alpha-amino acids, non-protein alpha-amino acids, beta-amino acids, gamma-amino acids, methyl-amino acids, polyamines, or sulfonic acids, either with or without sugars, organic acids, macronutrients, micronutrients or surfactants, and that enhances plant tolerance to biotic or abiotic stresses, including oxidative stress, salt stress, drought, chilling, or high temperature.

Disclosed in the present invention is the use of a mixture of molecules that contains at least one molecule from at least two of the following groups: protein alpha-amino acids, non-protein alpha-amino acids, beta-amino acids, gamma-amino acids, methyl-amino acids, polyamines, or sulfonic acids, either with or without macronutrients, micronutrients, sugars, organic acids, protein hydrolysates, humic acid, fulvic acid or surfactants to enhance sugar content, sugar accumulation or total sugar in an organ including leaves, roots, or fruit, or in the plant.

Also disclosed in the present invention is the method of developing a formulation for a fertilizer, fertilizer additive, or growth enhancer that comprises a mixture of molecules that contains at least one molecule from two of the following groups: protein alpha-amino acids, non-protein alpha-amino acids, beta-amino acids, gamma-amino acids, methyl-amino acids, polyamines, or sulfonic acids and also contains a suitable preservative wherein the preservative is selected from the group of preservatives such as benzoic acid, acetic acid, salicylic acid, propionic acid, sorbic acid, citric acid, or their salts.

Further disclosed in the present invention is the method of developing a formulation for a fertilizer, fertilizer additive, or growth enhancer that comprises a mixture of molecules that contains at least one molecule from two of the following groups: protein alpha-amino acids, non-protein alpha-amino acids, beta-amino acids, gamma-amino acids, methyl-amino acids, polyamines, or sulfonic acids wherein the fertilizer is solid or is a solution.

Further disclosed in the present invention is the method of developing a fertilizer comprising a mixture of at least one molecule from the following groups: protein alpha-amino acids, non-protein alpha-amino acids, beta-amino acids, gamma-amino acids, methyl-amino acids, polyamines, or sulfonic acids, wherein
the protein alpha-amino acid can he chosen from the group: alanine, arginine, asparagine, aspartate, cysteine, glutamate, glutamine, glycine, histidine, isoleucine, leucine, lysine, methionine, phenylalanine, proline, serine, threonine, tryptophan, tyrosine and valine;
the non-protein alpha-amino acid can be chosen from the group: ornithine, citrilline, homoserine, phosphoserine, homoarginine, arginosuccinic acid, S-adenosylmethionine, and homocysteine;
the beta-amino acid can be chosen from the group: BABA, beta-aminovaleric acid, beta-alanine, beta-amnoisobutyric acid, beta-homoserine and aminolevulinic acid;
the gamma-amino acid can be chosen from the group gamma-aminobutyric acid, 4-aminovaleric acid, and 5-aininovaleric acid;
the methyl-amino acid can be chosen from the group N-methyl-glycine (sarcosine) and N,N-dimethylglycine;
the polyamines can be chosen from the group putrescine, cadaverine, spermidine, and spermine;
the sulfonic acids can be chosen from the group methylsulfamic acid, ethanesulfonic acid, 2-amino ethanesulfonic acid (Tau), sulfoacetic acid, hypotaurine, formamidinesulfinic acid, hydroxylamine-O-sulfonic acid, allylsulfonate, sodium 3-mercapto-1-propanesulfonate, sodium 2,3-dimercaptopropanesulfonate monohydrate, 1-propanesulfonic acid, 3-hydroxypropane-1-sulfonic acid, 1,3-propanedisulfonic acid, 3-hydroxypropane-1-sulfonic acid and 3-amino-1-propanesulfonic acid;
the organic acids can be chosen from the group formic acid, acetic acid, propionic acid, butyric acid, caproic acid, oxalic acid, lactic, citric acid, malic acid, succinic acid, and fumaric acid or their salt form;
the macronutrients can be chosen from the group:
   inorganic N-based fertilizer including but not limited to N-based fertilizers, such as urea, ammonium sulfate, monoammonium phosphate (MAP), diammonium phosphate, ammonium sulfate, urea, ammonium, nitrate, potassium nitrate, ammonium nitrate, calcium nitrate, or ammonium phosphate sulfate;
   phosphorus (P) including but not limited to MAP, diammonium phosphate, single superphosphate [(Ca(H₂PO₄)₂·H₂O) and CaSO₄ also called monocalcium phosphate], triple superphosphate [Ca((H₂PO₄)₂·H₂O) known as calcium dihydrogen phosphate and as monocalcium phosphate], ammonium phosphate sulfate or rock phosphate;
   potassium (K) including but not limited to potassium sulfate, potassium nitrate, ammonium sulfate, potassium chloride;
   sulfate (S) including but not limited to potassium sulfate, ammonium sulfate, calcium sulfate (gypsum), or sodium sulfate;
   calcium (Ca) including but not limited to monocalcium phosphate, +2 CaSO₄ [gypsum]calcium nitrate, single superphosphate [(Ca(H₂PO₄)₂·H₂O) and CaSO₄ also called monocalcium phosphate], or triple superphosphate [Ca(H₂PO₄)₂·H₂O) known as calcium dihydrogen phosphate and as monocalcium phosphate]; and
   magnesium (Mg) including but not limited to soluble sources and semi-soluble sources including magnesium chloride, magnesium nitrate, magnesium sulfate ((MgSO₄·7 H₂O Epsom salt), kieserite (MgSO₄·H₂O), kainite MgSO₄·KCl·3H₂O, langbeinite (MgSO₄·K₂SO₄), schoenite (K₂SO₄·MgSO₄·6H₂O), dolomite (MgCO₃·CaCO₃), hydrated dolomite (MgO·CaO/MgO·Ca(OH)₂), magnesium oxide (MgO) or struvite (MgNH₄PO₄6H₂O;
the micronutrients can be chosen from the following group, boron (B), copper (Cu), iron (Fe), chloride (Cl), manganese (Mn), molybdenum (Mo) or zinc (Zn);
the sugars can be chosen from the group mannose, lactose, dextrose, erythrose, fructose, galactose, glucose, gulose, maltose, raffinose, ribose, ribulose, saccharose, stachyose, trehalose, xylose, xylulose, amylose, arabinose, fructose phosphate, adonitol, galactitol, glucitol, maltitol, mannitol, ribitol, sorbitol, or molasses;
the organic acids can be chosen from the group formic acid, acetic acid, propionic acid, butyric acid, caproic acid, oxalic acid, lactic, citric acid, malic acid, succinic acid, and fumaric acid or their salt form;
the protein hydrolysates can be derived from bacterial, yeast, algal, fungal, plant or animal protein source;
the humic substances can be humic acid or fulvic acid; and
the surfactants for emulsifying or wetting can be ionic or nonionic they include but not limited to polysorbates, polyoxyethylene (20) sorbitan monolaurate sodium dodecyl sulfate (sodium lauryl sulfate), lauryl dimethyl amine oxide, cetyltrimethylammonium bromide, polyethylene glycol p-(1,1,3,3-tetramethylbutyl)-phenyl ether, polyethoxylated alcohols, polyoxyethylene sorbitan, octoxynol, N,N-dimethyldodecylamine-N-oxide, hexadecyltrimethylammonium bromide, polyoxyl10lauryl ether, polyoxyethylene, monooctadecyl ether, sodium deoxycholate, sodium cholate, nonylphenol , ethoxylate, cyclodextrins or methylbenzethonium chloride. Surfactants and their uses are well known to those of ordinary skill in the art (85).

In one embodiment, the plant, plant organ or seed is treated with a solution having at least one protein alpha-amino acid in the range of about 0.005 ppm to about 50,000 ppm, in combination with at least one compound in the range of 0.005 ppm to about 50,000 ppm from the following group: non-protein alpha-amino acids, beta-amino acids, gamma-amino acids, methyl-amino acids, polyamines, or sulfonic acids either with or without macronutrients, micronutrients, sugars, organic acids, humic substances or surfactant. Most preferably, the protein alpha-amino acid is arginine, leucine, isoleucine, threonine or methionine.

In another embodiment, the plant, plant organ or seed is treated with a solution having at least one non-protein alpha-amino acid in the range of about 0.005 ppm to about 50,000 ppm, in combination with at least one compound in the range of 0.005 ppm to about 50,000 ppm from the following group: protein alpha-amino acids, beta-amino acids, gamma-amino acids, methyl-amino acids, polyamines, or sulfonic acids either with or without macronutrients, micronutrients, sugars, organic acids, humic substances or surfactant. Most preferably, the non-protein alpha-amino acid is ornithine, citrilime, homoserine, or phosphoserine.

In another embodiment, the plant, plant organ or seed is treated with a solution having at least one beta-amino acid in the range of about 0.005 ppm to about 50,000 ppm, in combination with at least one compound in the range of 0.005 ppm to about 50,000 ppm from the following group: protein alpha-amino acids, non-protein alpha-amino acids, beta-amino acids, gamma-amino acids, methyl-amino acids, polyamines, sulfonic acids or organic acid either with or without macronutrients, micronutrients or surfactant. Most preferably, the beta-amino acid is beta-aminobutyric acid, beta-alanine or beta-homoserine.

In another embodiment, the plant, plant organ or seed is treated with a solution having at least one gamma-amino acid in the range of about 0.005 ppm to about 50,000 ppm, in combination with at least one compound in the range of 0.005 ppm to about 50,000 ppm from the following group: protein alpha-amino acids, non-protein alpha-amino acids, beta-amino acids, gamma-amino acids, methyl-amino acids, polyamines, or sulfonic acids either with or without macronutrients, micronutrients, sugars, organic acids, humic substances or surfactant. Most preferably, the gamma-amino acid is gamma-aminobutyric acid, 4-aminovaleric acid, or 5-aminovaleric acid.

In another embodiment, the plant, plant organ or seed is treated with a solution having at least one methyl-amino acid in the range of about 0.005 ppm to about 50,000 ppm, in combination with at least one compound in the range of 0.005 ppm to about 50,000 ppm from the following group: protein alpha-amino adds, non-protein alpha-amino acids, beta-amino acids, gamma-amino acids, polyamines, or sulfonic acids either with or without macronutrients, micronutrients, sugars, organic acids, humic substances or surfactant. Most preferably, the methyl-amino acid is N-methyl-glycine or N,N-dimethylglycine.

In another embodiment, the plant, plant organ or seed is treated with a solution having at least one polyamine in the range of about 0.005 ppm to about 50,000 ppm, in combination with at least one compound in the range of 0.005 ppm to about 50,000 ppm from the following group: protein alpha-amino adds, non-protein alpha-amino acids, beta-amino acids, gamma-amino acids, methyl-amino acids, or sulfonic acids either with or without macronutrients, micronutrients, sugars, organic acids, humic substances or surfactant. Most preferably, the polyamine is putrescine or cadaverine.

In another embodiment, the plant, plant organ or seed is treated with a solution having at least one sulfonic acid in the range of about 0.005 ppm to about 50,000 ppm, in combination with at least one compound in the range of 0.005 ppm to about 50,000 ppm from the following group: protein alpha-amino acids, non-protein alpha-amino acids, beta-amino acids, gamma-amino acids, methyl-amino acids, or polyamines either with or without macronutrients, micronutrients, sugars, organic acids, humic substances or surfactant. Most preferably, the sulfonic acid is 2-amino ethanesulfonic acid (Tau), methylsulfamic acidsulfoacetic acid, or hypotaurine.

In another embodiment, the plant, plant organ or seed is treated with a solution having at least one organic acid in the range of about 0.005 ppm to about 50,000 ppm, in combination with at least one compound in the range of 0.005 ppm to about 50,000 ppm from the following group: protein alpha-amino acids, non-protein alpha-amino acids, beta-amino acids, gamma-amino acids, methyl-amino acids, or sulfonic acids either with or without macronutrients, micronutrients, sugars, humic substances or surfactant. Most preferably, the organic acid is acetic acid, propionic acid, butyric acid, citric acid, malic acid, succinic acid, or fumaric acid.

The spray or seed treatment solutions may contain additional components selected from the group of ammonium sulphate, monoammonium phosphate (MAP), diammonium phosphate, potassium sulfate, potassium dihydrogen phosphate, potassium chloride, magnesium sulphate, magnesium chloride, calcium chloride, monocalcium phosphate, calcium nitrate, monocalcium phosphate, or calcium dihydrogen phosphate and trace elements, wherein the trace elements are selected from the group of Fe, Mn, Cu, Zn, B and Mo.

The pH of the fertilizer can be between 4.5 and 8.5. preferably between 5.5 and 7.5 and most preferably between 6.0 and 7.0.

Seed priming techniques (86) are well known to those of ordinary skill in the art. For review see (86, 87) and references therein.

### DESCRIPTION Of THE PRACTICE OF THE INVENTION

In the practice of the present invention a solution comprising a mixture of at least one molecule from two or more of the following groups of molecules: protein alpha-amino acids, non-protein alpha-amino acids, beta-amino acids, gamma-amino acids, methyl-amino acids, polyamines, or sulfonic acids, with or without the addition of sugars, organic acids, macronutrients and micronutrients is applied directly to seeds or to the roots, stems, or foliage of the plant. The application stimulates growth and productivity such as increased yields, organ growth or sugar production.

Solutions prepared according to the present invention may be applied to plants by any one of a number of means including but not limited to seed soak, seed priming, foliar spray, spray on plant organs, liquid chemical injection, soil injection, liquid chemical dripping, root or soil drench or a fertilizer additive. The preferred use is as a liquid but the formulation can be used as a dry powder or granules. For the aqueous formulation, application rates of the invention are generally 0.5 to 100 gal per acre, in particular 2 to 50 gal per acre, or preferably 10 to 20 gal per acre. For the active ingredients (chemical compounds minus water), application rates are generally 0.1 to 2,000 g per acre, in particular 1 to 1,000 g per acre, or preferably 0.5 to 500 g per acre.

All patents, patent applications, and references cited in this disclosure are expressly incorporated herein by reference and are set forth in the Bibliography. The above disclosure generally describes the present invention. A more complete understanding can be obtained by reference to the following specific examples, which are provided for purposes of illustration only and are not intended to limit the scope of the invention.

### EXAMPLE 1

### Development of a Formulation for use as a Foliar Spray, Seed Treatment, or Soil Drench that Contains at Least One Protein Alpha-Amino Acid and One Non-Protein Alpha-Amino Acid

Make an aqueous solution with 25 ppm isoleucine, 75 ppm citrulline, 10 ppm zinc sulfate, 10 ppm manganese sulfate, 5 ppm boric acid, and 1 ppm sodium molybdate, pH 7.0. Apply the formulation as a spray or drench at a rate of 10 gal/acre or alternatively, incubate seeds in the solution for 2-8 hours, let the seeds dry, and then plant them.

### EXAMPLE 2

### Development of a Formulation for use as a Foliar Spray, Seed Treatment, or Soil Drench that Contains at Least One Protein Alpha-Amino Acid and One Beta-Amino Acid

Make an aqueous solution with 100 ppm isoleucine, 30 ppm BABA, 100 ppm potassium sulfate, 20 ppm zinc sulfate, 20 ppm manganese sulfate, 10 ppm boric acid, and 1 ppm sodium molybdate, pH 6.7. Apply the formulation as a spray or drench at a rate of 10 gal/acre or alternatively, incubate seeds in the solution for 2-8 hours, let the seeds dry, and then plant them.

### EXAMPLE 3

### Development of a Formulation for use as a Foliar Spray, Seed Treatment, or Soil Drench that Contains at Least One Protein Alpha-Amino Acid and One Gamma-Amino Acid

Make an aqueous solution with 130 ppm isoleucine, 100 ppm GABA, 50 ppm potassium sulfate, 50 ppm magnesium chloride, 10 ppm zinc sulfate, 10 ppm manganese sulfate, 10 ppm boric acid, and 1 ppm sodium molybdate, pH 6.8. Apply the formulation as a spray or drench at a rate of 10 gal/acre or alternatively, incubate seeds in the solution for 2-8 hours, let the seeds dry, and then plant them.

### EXAMPLE 4

### Development of a Formulation for use as a Foliar Spray, Seed Treatment, or Soil Drench that Contains at Least One Protein Alpha-Amino Acid and One Methyl-Amino Acid

Make an aqueous solution with 100 ppm leucine, 150 ppm N-methyl-glycine, 150 ppm sodium succinate, 50 ppm calcium succinate, 50 ppm magnesium chloride, and 5 ppm boric acid, pH6.8. Apply the formulation as a spray or drench at a rate of 10 gal/acre or alternatively, incubate seeds in the solution for 2-8 hours, let the seeds dry, and then plant them.

### EXAMPLE 5

### Development of a Formulation for use as a Foliar Spray, Seed Treatment, or Soil Drench that Contains at Least One Protein Alpha-Amino Acid and One Polyamide

Make an aqueous solution with 100 ppm isoleucine, 25 ppm putrescine, 500 ppm potassium acetate, 150 ppm potassium sulfate, 50 ppm magnesium chloride, 20 ppm zinc sulfate, 20 ppm manganese sulfate, 10 ppm boric acid, and 1 ppm sodium molybdate, pH 6.8. Apply the formulation as a spray or drench at a rate of 10 gal/acre or alternatively, incubate seeds in the solution for 2-8 hours, let the seeds dry, and then plant them.

### EXAMPLE 6

### Development of a Formulation for use as a Foliar Spray, Seed Treatment, or Soil Drench that Contains at Least One Protein Alpha-Amino Acid and One Sulfonic Acid

Make an aqueous solution with 80 ppm isoleucine, 5 ppm Tau, 250 ppm sodium acetate, 25 ppm magnesium chloride, 20 ppm zinc sulfate, 20 ppm manganese sulfate, 10 ppm boric acid, 1 ppm sodium molybdate, pH 6.8. Apply the formulation as a spray or drench at a rate of 10 gal/acre or alternatively, incubate seeds in the solution for 2-8 hours, let the seeds dry, and then plant them.

### EXAMPLE 7

### Development of a Formulation for use as a Foliar Spray, Seed Treatment, or Soil Drench that Contains at Least One Non-Protein Alpha-Amino Acid and One Beta-Amino Acid

Make an aqueous solution with 250 ppm citrulline, 50 ppm BABA, 100 ppm potassium sulfate, 20 ppm zinc sulfate, 20 ppm manganese sulfate, 10 ppm boric acid, and 1 ppm sodium molybdate, pH 6.7. Apply the formulation as a spray or drench at a rate of 10 gal/acre or alternatively, incubate seeds in the solution for 2-8 hours, let the seeds dry, and then plant them.

### EXAMPLE 8

### Development of a Formulation for use as a Foliar Spray, Seed Treatment, or Soil Drench that Contains at Least One Non-Protein Alpha-Amino Acid and One Gamma-Amino Acid

Make an aqueous solution with 125 ppm ornithine, 200 ppm GABA, 50 ppm potassium sulfate, 50 ppm magnesium chloride, 10 ppm zinc sulfate, 10 ppm manganese sulfate, 10 ppm boric acid, 1 ppm sodium molybdate, pH 6.8. Apply the formulation as a spray or drench at a rate of 10 gal/acre or alternatively, incubate seeds in the solution for 2-8 hours, let the seeds dry, and then plant them.

### EXAMPLE 9

### Development of a Formulation for use as a Foliar Spray, Seed Treatment, or Soil Drench that Contains at Least One Non-Protein Alpha-Amino Acid and One Methyl-Amino Acid

Make an aqueous solution with 250 ppm citrulline, 150 ppm N-methyl-glycine, 150 ppm sodium succinate, 50 ppm calcium succinate, 50 ppm magnesium chloride, and 5 ppm boric acid, pH6.8. Apply the formulation as a spray or drench at a rate of 10 gal/acre or alternatively, incubate seeds in the solution for 2-8 hours, let the seeds dry, and then plant them.

### EXAMPLE 10

### Development of a Formulation for use as a Foliar Spray, Seed Treatment, or Soil Drench that Contains at Least One Non-Protein Alpha-Amino Acid and One Polyamide

Make an aqueous solution with 25 ppm homoserine, 25 ppm putrescine, 500 ppm potassium acetate, 150 ppm potassium sulfate, 50 ppm magnesium chloride, 20 ppm zinc sulfate, 20 ppm manganese sulfate, 10 ppm boric acid, and 1 ppm sodium molybdate, pH 6.8. Apply the formulation as a spray or drench at a rate of 10 gal/acre or alternatively, incubate seeds in the solution for 2-8 hours, let the seeds dry, and then plant them.

### EXAMPLE 11

### Development of a Formulation for use as a Foliar Spray, Seed Treatment, or Soil Drench that Contains at Least One Non-Protein Alpha-Amino Acid and One Sulfonic Acid

Make an aqueous solution with 100 ppm citrulline, 15 ppm Tau, 250 ppm sodium acetate, 25 ppm magnesium chloride, 20 ppm zinc sulfate, 20 ppm manganese sulfate, 10 ppm boric acid, and 1 ppm sodium molybdate, pH 6.8. Apply the formulation as a spray or drench at a rate of 10 gal/acre or alternatively, incubate seeds in the solution for 2-8 hours, let the seeds dry, and then plant them.

### EXAMPLE 12

### Development of a Formulation for use as a Foliar Spray, Seed Treatment, or Soil Drench that Contains at Least One Beta-Amino Acid and One Gamma-Amino Acid

Make an aqueous solution with 50 ppm BABA, 100 ppm GABA, 150 potassium sulfate, 25 ppm magnesium chloride, 10 ppm manganese sulfate, 5 ppm boric acid, and 1 ppm sodium molybdate, pH 6.8. Apply the formulation as a spray or drench at a rate of 10 gal/acre or alternatively, incubate seeds in the solution for 2-8 hours, let the seeds dry, and then plant them.

### EXAMPLE 13

### Development of a Formulation for use as a Foliar Spray, Seed Treatment, or Soil Drench that Contains at Least One Beta-Amino Acid and One Methyl-Amino Acid

Make an aqueous solution with 10 ppm BABA, 150 ppm N-methyl-glycine, 150 ppm sodium succinate, 50 ppm calcium succinate, 50 ppm magnesium chloride, and 5 ppm boric acid, pH6.8. Apply the formulation as a spray or drench at a rate of 10 gal/acre or alternatively, incubate seeds in the solution for 2-8 hours, let the seeds dry, and then plant them.

### EXAMPLE 14

### Development of a Formulation for use as a Foliar Spray, Seed Treatment, or Soil Drench that Contains at Least One Beta-Amino Acid and One Polyamide

Make an aqueous solution with 50 ppm beta-homoserine, 100 ppm cadaverine, 100 ppm sodium acetate, pH 6.8. Apply the formulation as a spray or drench at a rate of 10 gal/acre or alternatively, incubate seeds in the solution for 2-8 hours, let the seeds dry, and then plant them.

### EXAMPLE 15

### Development of a Formulation for use as a Foliar Spray, Seed Treatment, or Soil Drench that Contains at Least One Beta-Amino Acid and One Sulfonic Acid

Make an aqueous solution with 10 ppm BABA, 150 ppm Tau, 50 ppm sodium acetate, 25 ppm magnesium chloride, 20 ppm zinc sulfate, 20 ppm manganese sulfate, 5 ppm boric acid, and 1 ppm sodium molybdate, pH 6.8. Apply the formulation as a spray or drench at a rate of 10 gal/acre or alternatively, incubate seeds in the solution for 2-8 hours, let the seeds dry, and then plant them.

### EXAMPLE 16

### Development of a Formulation for use as a Foliar Spray, Seed Treatment, or Soil Drench that Contains at Least Gamma-Amino Acid and one Methyl-Amino Acid

Make an aqueous solution with 100 ppm 5-aminovaleric acid, 150 ppm N-methyl-glycine, 50 ppm potassium citrate, and 10 ppm boric acid, pH6.8. Apply the formulation as a spray or drench at a rate of 10 gal/acre or alternatively, incubate seeds in the solution for 2-8 hours, let the seeds dry, and then plant them.

### EXAMPLE 17

### Development of a Formulation for use as a Foliar Spray, Seed Treatment, or Soil Drench that Contains at Least One Gamma-Amino Acid and One Polyamide

Make an aqueous solution with 200 ppm GABA, 50 ppm putrescine, 900 ppm potassium acetate, 100 ppm potassium sulfate, 50 ppm magnesium chloride, 20 ppm zinc sulfate, 20 ppm manganese sulfate, 10 ppm boric acid, 1 ppm sodium molybdate, pH 6.8. Apply the formulation as a spray or drench at a rate of 10 gal/acre or alternatively, incubate seeds in the solution for 2-8 hours, let the seeds dry, and then plant them.

### EXAMPLE 18

### Development of a Formulation for use as a Foliar Spray, Seed Treatment, or Soil Drench that Contains at Least One Gamma-Amino Acid and One Sulfonic Acid

Make an aqueous solution with 10-500 ppm GABA, 0.1-250 ppm Tau, and 600 ppm magnesium sulfate, pH 6.8. Apply the formulation as a spray or drench at a rate of 10 gal/acre or alternatively, incubate seeds in the solution for 2-8 hours, let the seeds dry, and then plant them.

### EXAMPLE 19

### Development of a Formulation for use as a Foliar Spray or Soil Drench that Contains at Least One Gamma-Amino Acid, One Sulfonic Acid, Macronutrients and Micronutrients

Make an aqueous solution with 10-500 ppm GABA, 0.1-250 ppm Tau, 100 ppm potassium sulfate, 50 ppm magnesium chloride, 20 ppm manganese sulfate, 20 ppm zinc sulfate, 10 ppm boric acid, and I ppm sodium molybdate, pH 6.8. Apply the formulation as a spray or drench at a rate of 10 gal/acre.

### EXAMPLE 20

### Development of a Formulation for use as a Foliar Spray or Soil Drench that Contains at Least One Gamma-Amino Acid, One Sulfonic Acid, One Organic Acid, Macronutrients and Micronutrients

Make an aqueous solution with 10-500 ppm GABA, 0.1-250 ppm Tau, 900 ppm potassium acetate, 100 ppm potassium sulfate, 50 ppm magnesium chloride, 20 ppm manganese sulfate, 20 ppm zinc sulfate, 10 ppm boric acid, and 1 ppm sodium molybdate, pH 6.8. Apply the formulation as a spray or drench at a rate of 10 gal/acre.

### EXAMPLE 21

### Development of a Formulation for use as a Foliar Spray, Seed Treatment, or Soil Drench that Contains at Least Polyamide and one Sulfonic Acid

Make an aqueous solution with 10 ppm putrescine, 150 ppm Tau, 100 ppm sodium acetate, 100 ppm potassium sulfate, 50 ppm magnesium chloride, 20 ppm manganese sulfate, 10 ppm boric acid, and 1 ppm sodium molybdate, pH 6.8. Apply the formulation as a spray or drench at a rate of 10 gal/acre or alternatively, incubate seeds in the solution for 2-8 hours, let the seeds dry, and then plant them.

### EXAMPLE 22

### Development of a Formulation for use as a Foliar Spray, Seed Treatment, or Soil Drench that Contains at Least One Beta-Amino Acid, One Gamma-Amino Acid and One Methyl Amino Acid

Make an aqueous solution with 25 ppm BABA, 125 ppm GABA, 100 ppm N-methyl-glycine, 100 ppm sodium acetate, 100 ppm potassium sulfate, 50 ppm magnesium chloride, manganese sulfate, 10 ppm boric acid, 1 ppm sodium molybdate, pH 6.8. Apply the formulation as a spray or drench at a rate of 10 gal/acre or alternatively, incubate seeds in the solution for 2-8 hours, let the seeds dry, and then plant them.

### EXAMPLE 23

### Development of a Formulation for use as a Foliar Spray, Seed Treatment, or Soil Drench that Contains at Least One Beta-Amino Acid, One Gamma-Amino Acid, One Methyl Amino Acid, and One Sulfonic Acid

Make an aqueous solution with 25 ppm BABA, 125 ppm GABA, 100 ppm N-methyl-glycine, and 50 ppm Tau, 100 ppm potassium succinate, 100 ppm potassium sulfate, 50 ppm magnesium chloride, manganese sulfate, 10 ppm boric acid, 1 ppm sodium molybdate, and pH 6.8. Apply the formulation as a spray or drench at a rate of 10 gal/acre or alternatively, incubate seeds in the solution for 2-8 hours, let the seeds dry, and then plant them.

### EXAMPLE 24

### Development of a Formulation for the use as a Foliar Spray, Seed Treatment, or Soil Drench that Contains at Least One Gamma-Amino Acid and One Polyamine

Make an aqueous solution with 250 ppm GABA, 50 ppm putrescine, 900 ppm potassium acetate, 100 ppm potassium sulfate, 50 ppm magnesium chloride, 20 ppm manganese sulfate, 20 ppm zinc sulfate, 10 ppm boric acid, and 1 ppm sodium molybdate, pH 6.8. Apply the formulation as a spray or drench at a rate of 10 gal/acre or alternatively, incubate seeds in the solution for 2-8 hours, let the seeds dry, and then plant them.

### EXAMPLE 25

### Increased Brix Levels in Alfalfa Treated with a Foliar Spray Containing a Gamma Amino Acid and a Polyamine

Alfalfa plants (150-day old) were sprayed with one of two formulations at a rate of 10 gal/acre. One formulation was the same as described in Example 24 (Treatment 1), and a second formulation was the same formulation as described in Example 24 but without putrescine (Treatment 2). Two days after treatment, the above-ground portions were harvested. The above-ground portions of untreated alfalfa (control group) were harvested at the same time. Liquid extracts were collected from the above-ground portions of the plants. °Brix values were determined from the liquid extracts using a refractometer. Nine (9) samples for each of the three conditions were evaluated. Results are shown in Table 2.

TABLE 2
Brix values of the above-ground portion of alfalfa plants

| | °Brix | | |
|---|---|---|---|
| | No Treatment | Treatment 1 | Treatment 2 |
| n | 9 | 9 | 9 |
| Mean | 9.21 | 9.88 | 8.09 |
| SD | 0.66 | 0.76 | 0.93 |

Planned comparison, one-tailed t-tests were performed on the °Brix values. The results showed that alfalfa treated with the formulation containing both a gamma amino acid and a polyamine (Treatment 1) had 7% higher °Brix than untreated alfalfa (Control) (t(16)=1.99, p=0.032), and 22% higher °Brix than alfalfa treated with the formulation containing a gamma amino acid but no polyamine (Treatment 2) (t(16)=4.45, p<0.001).

### EXAMPLE 26

### Increased Root Weight of Swiss Chard Seedlings After Seed Priming with a Solution Containing a Gamma Amino Acid and a Sulfonic Acid

Swiss chard seeds were primed for 8 hours with one of three solutions. One solution was the formulation described in Example 18, wherein GABA was 130 ppm and Tau was 160 ppm (Treatment 1). Another solution was the formulation described in Example 18, wherein GABA was 130 ppm and Tau was 0 ppm (Treatment 2). A third solution was water (Control). Before treatment, all seeds were rinsed with water for 0.5 hr. The seeds were then incubated for 2 hours in one of the three solutions. Following the priming, the seeds were dried for two days and then planted in soil. Plants were maintained in a grow room at 21-22° C. with 60-70% relative humidity, under cool white fluorescent lights with a 16-hr daylight. After 40 days, the plants were harvested and the roots were weighed. Table 3 shows the results.

TABLE 3
Root weight (g) of Swiss chard seedlings

| | Root weight (g) | | |
|---|---|---|---|
| | Control | Treatment 1 | Treatment 2 |
| n | 12 | 12 | 12 |
| Mean | 0.077 | 0.166 | 0.094 |
| SD | 0.042 | 0.121 | 0.084 |

Planned comparison one-tailed, t-tests were performed on the root weights (g) of the Swiss chard seedlings. The results showed that the seedlings whose seeds had been primed with both the gamma amino acid and sulfonic acid plus magnesium sulfate had more than twice the root mass as the control plants, t(22) =2.405, p=0.012, and 77% more root mass than the seedlings whose seeds had been primed only with the gamma amino acid plus magnesium sulfate, t(22) =1.69, p=0.05.

### EXAMPLE 27

### Increased Primary Root Length of Sugar Beet Seedlings After Seed Priming with a Solution Containing a Gamma Amino Acid and a Sulfonic Acid

Sugar beet seeds were primed for 8 hours with one of two solutions. One solution was the formulation described in Example 18, wherein GABA was 35 ppm and Tau was 40 ppm (Treatment). The other solution was water (Control). Before treatment, all seeds were rinsed with water. The seeds were then incubated for 2 hours in one of the two solutions. Following the priming, the seeds were dried for two days and placed on damp germination paper, which was then rolled up and sealed in plastic bags. The bags were maintained in a growth chamber at 25° C., under cool white fluorescent lights with a 16-hr daylight. After 7 days, the seedlings were photographed and the roots were digitized to determine root length. Table 4 shows the results.

TABLE 4
Root length (cm) of sugar beet seedlings

Root length (cm)

| | Control | Treatment |
|---|---|---|
| n | 100 | 100 |
| Mean | 6.55 | 7.49 |
| SD | 3.25 | 1.91 |

The results of a t-test showed that the sugar beet seedlings in the Treatment condition (seeds treated with formulation containing GABA, Tau, and magnesium sulfate) had 14% longer primary roots than seedlings in the Control condition (seeds treated with water) (t(198)=2.49, p=0.01).

### EXAMPLE 28

### Increased Brix Levels in Corn Treated with a Foliar Spray Containing a Gamma-Amino Acid, a Sulfonic Acid, Macronutrients and Micronutrients

Corn plants (110-day old) were sprayed at a rate of 10 gal/acre with the formulation described in Example 19, wherein GABA was 250 ppm and Tau was 1 ppm. Two days after treatment, the leaves of the plants were harvested. The leaves of untreated corn plants (control group) were harvested at the same time. Liquid extracts were collected from the leaves of the plants. °Brix values were determined from the liquid extracts using a refractometer. Eighteen (18) samples for each condition were evaluated. Results are shown in Table 5.

TABLE 5
Brix values of corn leaves

°Brix

| | No Treatment | Treatment |
|---|---|---|
| n | 18 | 18 |
| Mean | 10.07 | 11.36 |
| SD | 1.12 | 1.90 |

A planned comparison, one-tailed t-test was performed on the °Brix values. The results showed that the leaves of corn treated with a formulation containing a gamma-amino acid, a sulfonic acid, macronutrients and micronutrients had 13% higher °Brix than the leaves of untreated corn (control), t(27)=−2.47, p=0.02.

### EXAMPLE 29

### Increased Brix Levels in Triticale Treated with a Foliar Spray Containing a Gamma-Amino Acid, a Sulfonic Acid, Macro-Nutrients and Micro-Nutrients

Triticale plants (150-day old) were sprayed at a rate of 10 gal/acre with one of three formulations. The first formulation (Treatment 1) was the same as described in Example 20, wherein GABA was 250 ppm and Tau was 1 ppm. The second formulation (Treatment 2) was the same as the first formulation minus Tau. The third formulation (Treatment 3) was the same as the first formulation minus GABA. Two days after treatment, the above-ground portions of the plants were harvested. The above-ground portions of untreated triticale plants (Control) were harvested at the same time. Liquid extracts were collected from the leaves of the plants. °Brix values were determined from the liquid extracts using a refractometer. Five (5) samples for each condition were evaluated. Table 6 shows the results.

TABLE 6
Brix values in triticale leaves

| | °Brix | | | |
|---|---|---|---|---|
| | Control | Treatment 1 | Treatment 2 | Treatment 3 |
| n | 5 | 5 | 5 | 5 |
| Mean | 10.4 | 12.0 | 11.6 | 10.9 |
| SD | 0.51 | 0.74 | 0.55 | 0.39 |

The highest °Brix levels in triticale leaves were obtained with Treatment 1, i.e., a formulation containing a gamma-amino acid, a sulfonic acid, macro-nutrients and micro-nutrients. Planned comparison t-tests were performed on the °Brix values. The results showed triticale leaves sprayed with Treatment 1 had 15% higher °Brix than the leaves of untreated triticale plants (Control) (t(8)=3.96, p=0.004), 10% higher °Brix than leaves sprayed with Treatment 3 (t(8)=2.99, p=0.02), and 4% higher °Brix than leaves sprayed with Treatment 2 (t(8)=1.07, p=0.32).

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### BIBLIOGRAPHY

1. Sinclair T R & Horie T (1989) Leaf nitrogen, photosynthesis, and crop radiation use efficiency: A review. Crop Sci 29(1):90-98.
2. Lawlor D W (1995) Photosynthesis, productivity and environment. J Exp Bot 46(special issue):1449-1461.
3. Ceccotti S P (1996) Plant nutrient sulphur—a review of nutrient balance, environmental impact and fertilizers. Fertilizers and Environment: Proceedings of the International Symposium “Fertilizers and Environment”, held in Salamanca, Spain, 26-29, Sep., 1994, ed Rodriguez-Barrueco C (Springer Netherlands, Dordrecht), pp 185-193.
4. Shaviv A & Mikkelsen R L (1993) Controlled-release fertilizers to increase efficiency of nutrient use and minimize environmental degradation-A review.Fert Res 35(1):1-12.
5. Kopriva S, et al. (2002) Interaction of sulfate assimilation with carbon and nitrogen metabolism in Lemna minor. Plant Physiol 130(3):1406-1413.
6. Kopriva S & Rennenberg H (2004) Control of sulphate assimilation and glutathione synthesis: interaction with N and C metabolism. J Exp Bot 55(404):1831-1842.
7. Stulen I (1986) Interactions between nitrogen and carbon metabolism in a whole plant context. Fundamental, Ecological and Agricultural Aspects of Nitrogen Metabolism in Higher Plants Developments in Plant and Soil Sciences, eds H. L, J. J. N, & I. S (Springer, Dordrecht), Vol 19.
8. Jamal A, Moon Y-S, & Abdin M Z (2010) Sulphur—a general overview and interaction with nitrogen. Aust J Crop Sci 4:523-529.
9. Sinclair T R & Rufty T W (2012) Nitrogen and water resources commonly limit yield increases, not necessarily plant genetics. Glob Food Sec 1:94-98.
10. Malnou C S, Jaggard K W, & Sparkes D L (2008) Nitrogen fertilizer and the efficiency of the sugar beet crop in late summer. Eur J Agron 28(1):47-56.
11. Oparka K J, Davies H V, & Prior DAM (1987) The Influence of Applied Nitrogen on Export and Partitioning of Current Assimilate by Field-grown Potato Plants. Ann Bot 59(3):311-323.
12. Van Quy L, Lamaze T, & Champigny M-L (1991) Short-term effects of nitrate on sucrose synthesis in wheat leaves. Planta 185(1):53-57.
13. Champigny M L, et al. (1992) The short-term effect of NO3— and NH3 assimilation on sucrose synthesis in leaves. J Plant Physiol 139(3):361-368.
14. Rai V (2002) Role of amino acids in plant responses to stresses. Biol Plant 45:481-487.
15. Wang W, Cang L, Zhou D-M, & Yu Y-C (2016) Exogenous amino acids increase antioxidant enzyme activities and tolerance of rice seedlings to cadmium stress. Environ. Prog. Sustainable Energy 36:155-161.
16. Abd El-Samad A, Shaddad M A K, & Barakat N (The role of amino acids in improvement i in salt tolerance of crop plants. J Stress Physiol Biochem 6:25-37.
17. Vranova V, Rejsek K, Skene K R, & Formanek P (2011) Non-protein amino acids: plant, soil and ecosystem interactions. Plant and Soil 342 (1): 31-48.
18. Jakab G, et al. (2001) β-aminobutyric acid-induced resistance in plants. Eur J Plant Pathol 107(1):29-37.
19. Cohen Y (2002) β-aminobutyric acid-induced resistance against plant pathogens. Plant Dis. 86:448-457.
20. Cohen Y, Vaknin M, & Mauch-Mani B (2016) BABA-induced resistance: milestones along a 55-year journey. Phytoparasitica 44:513-538.
21. Vijayakumari K, Jisha K C, & Puthur J T (2016) GABA/BABA priming: a means for enhancing abiotic stress tolerance potential of plants with less energy investments on defence cache. Acta Physiol Plant 38(9):230.
22. Kinnersley A M & Turano F J (2000) Gamma Aminobutyric Acid (GABA) and Plant Responses to Stress. Crit Rev Plant Sci 19:479-509.
23. Johnson L B & Peel J L (2012) U.S. Pat. No. 8,202,822.
24. Todorova D, Katerova Z, Alexieva V, & Sergiev I (2015) Polyamines-possibilities for application to increase plant tolerance and adaptation capacity to stress. Gen Plant Physiol 5:123-144.
25. Gupta K, Dey A, & Gupta B (2013) Plant polyamines in abiotic stress responses. Acta Physiol Plant 35:1239-1244.
26. Jancewicz A L, Gibbs N M, & Masson P H (2016) Cadaverine's functional role in plant development and environmental response. Front Plant Sci 7:870.
27. Abbasi N A, Ali I, Hafiz I A, & Khan A S (2017) Application of polyamines in horticulture: A review. Int J Biosci 10:319-342.
28. Suzuki A, Kajita T, & Furushima M (1989) 4877447.
29. Harris G P (1956) Amino acids as sources of nitrogen for the growth of isolated oat embryos. New Phytol 55(2):253-268.
30. Skinner J C & Street H E (1954) Studies on the growth of excised roots. New Phytol 53(1):44-67.
31. Harris G P (1959) Amino acids as nitrogen sources for the growth of excised roots of red clover. New Phytol 58(3):330-344.
32. Näsholm T & Svennerstam H (2011) U.S. Pat. No. 9,481,610.
33. Teixeira W F, et al. (2017) Foliar and seed application of amino acids affects the antioxidant metabolism of the soybean crop. Front Plant Sci 8:327.
34. Dickinson K, O'Brien J, Ashmead Sd, & Hartle J (2005) Appl. No. 10/969,584.
35. Svec C H & Vidyarthi A (2001) U.S. Pat. NO. 6,241,795.
36. Smith A G, Svec C H, & Fiery M D (2013) U.S. Pat. No. 8,444,742.
37. Nonomura A M & Benson A A (1997) U.S. Pat. No. 5,597,400.
38. Colla G, Rouphael Y, Canaguier R, Svecova E, & Cardarelli M (2014) Biostimulant action of a plant-derived protein hydrolysate produced through enzymatic hydrolysis. Front Plant Sci 5:448.
39. Colla G, et al. (2015) Protein hydrolysates as biostimulants in horticulture. Sci Hortic 196:28-38.
40. Makarov H B (1992) RU2016510.
41. Nasholm L T & Öhlund JEG (2004) Appl. No. 10/276494.
42. Nasholm L T & Öhlund JEG (2000) EP1284945.
43. da Rocha I M, et al. (2012) Exogenous ornithine is an effective precursor and the delta-ornithine amino transferase pathway contributes to proline accumulation under high N recycling in salt-stressed cashew leaves. J Plant Physiol 169(1):41-49.
44. Van Andel O M (1958) Investigations on plant chemo-therapy II. Influence of amino acids on the relation plant-pathogen. Planteziekten 64:307-327.
45. Hodge S, Thompson G A, & Powell G (2007) Application of DL-β-aminobutyric acid (BABA) as a root drench to legumes inhibits the growth and reproduction of the pea aphid Acyrthosiphon pisum (Hemiptera: Aphididae). Bull Entomol Res 95(5):449-455.
46. Jisha K C & Puthur J T (2016) Seed priming with beta-amino butyric acid improves abiotic stress tolerance in rice seedlings. Rice Sci 23(5):242-254.
47. Cohen Y (2000) U.S. Pat. No. 6,075,051.
48. Kinnersley A, Coleman R, & Tolbert E (1995) U.S. Pat. No. 5,439,873.
49. Kathiresan A, Miranda J, Chinnappa C C, & Reid D M (1998) g-aminobutyric acid promotes stem elongation in Stellaria longipes: the role of ethylene. Plant Growth Reg 26:131-137.
50. Kinnersley A M & Lin F (2000) Receptor modifiers indicate that GABA is a potential modulator of ion transport in plants. Plant Growth Reg 9:137-146.
51. Li W, et al. (2016) Exogenous y-aminobutyric acid (GABA) application improved early growth, net photosynthesis, and associated physio-biochemical events in maize. Front Plant Sci 7:919.
52. Song H, Xu X, Wang H, Wang H, & Tao Y (2010) Exogenous y-aminobutyric acid alleviates oxidative damage caused by aluminium and proton stresses on barley seedlings. J Sci Food Agric 90(9): 1410-1416.
53. Wang Y, et al. (2017) y-Aminobutyric acid imparts partial protection from salt stress injury to maize seedlings by improving photosynthesis and upregulating osmoprotectants and antioxidants. Sci Rep 7:43609.
54. Schirra M, D'Aquino S, Cabras P, & Angioni A (2011) Control of postharvest diseases of fruit by heat and fungicides: efficacy, residue levels, and residue persistence. A review. J Agric Food Chem 59:8531-8542.
55. Yang A, Cao S, Yang Z, Cai Y, & Zheng Y (2011) γ-Aminobutyric acid treatment reduces chilling injury and activates the defence response of peach fruit. Food Chem 129(4):1619-1622.
56. Aghdam M S, Naderi R, Jannatizadeh A, Sarcheshmeh M A A, & Babalar M (2016) Enhancement of postharvest chilling tolerance of anthurium cut flowers by γ-aminobutyric acid (GABA) treatments. Sci Hortic 198:52-60.
57. Malekzadeh P, Khara J, & Heydari R (2014) Alleviating effects of exogenous Gamma-aminobutiric acid on tomato seedling under chilling stress. Physiol Mol Biol Plants 20(1):133-137.
58. Krishnan S, Laskowski K, Shukla V, & Merewitz E B (2013) Mitigation of drought stress damage by exogenous application of a non-protein amino acid γ-aminobutyric acid on perennial ryegrass. J Am Soc Hortic Sci 138:358-366.
59. Yong B, et al. (2017) Exogenous application of GABA improves PEG-induced drought tolerance positively associated with GABA-shunt, polyamines, and proline metabolism in white clover. Front Physiol 8(1107).
60. Vijayakumari K & Puthur J T (2016) γ-Aminobutyric acid (GABA) priming enhances the osmotic stress tolerance in Piper nigrum Linn plants subjected to PEG-induced stress. Plant Growth Regul 78:57-67.
61. Li Z, Yu J, Peng Y, & Huang B (2016) Metabolic pathways regulated by γ-aminobutyric acid (GABA) contributing to heat tolerance in creeping bentgrass (Agrostis stolonifera). Sci Rep 6:30338.
62. Nayyar H, Kaur R, & Kaur S (2014) γ-aminobutyric acid (GABA) imparts partial protection from heat stress injury to rice seedlings by improving leaf turgor and upregulating osmoprotectants and antioxidants. J Plant Growth Regul 33:408.
63. Mahmud J, et al. (2017) γ-aminobutyric acid (GABA) confers chromium stress tolerance in Brassica juncea L. by modulating the antioxidant defense and glyoxalase systems. Ecotoxicol 26:675.
64. Li MF, Guo S J, Yang X H, Meng Q W, & Wei X J (2016) Exogenous gamma-aminobutyric acid increases salt tolerance of wheat by improving photosynthesis and enhancing activities of antioxidant enzymes. Biol Plant 60:123-131.
65. Kinnersley A M, Coleman R D, Kinnersley C-Y, & McIntyre J L (1998) U.S. Pat. No. 5,840,656.
66. Liu J-H, Kitashiba H, Wang J, Ban Y, & Moriguchi T (2007) Polyamines and their ability to provide environmental stress tolerance to plants. Plant Biotechnol J 24(1):117-126.
67. Keunen E L S, Peshev D, Vangronsveld J, Van Den Ende W I M, & Cuypers A N N (2013) Plant sugars are crucial players in the oxidative challenge during abiotic stress: extending the traditional concept. Plant Cell Environ 36(7):1242-1255.
68. Trouvelot S, et al. (2014) Carbohydrates in plant immunity and plant protection: roles and potential application as foliar sprays. Front Plant Sci 5:592.
69. Yamashita T T (1996) U.S. Pat. No. 5,549,729.
70. Yamashita T T (2001) U.S. Pat. No. 6,309,440.
71. Morgan J M (1984) Osmoregulation and water stress in higher plants. Annu Rev Plant Physiol 35(1):299-319.
72. Kochian L V, et al. (2002) Mechanisms of metal resistance in plants: aluminum and heavy metals. Plant Soil 247(1):109-119.
73. Talebi M, Hadavi E, & Jaafari N (2014) Foliar sprays of citric acid and malic acid modify growth, flowering, and root to shoot ratio of Gazania (Gazania rigens L.): A comparative analysis by ANOVA and structural equations modeling. Adv Agric 2014:6.
74. Binder T P, et al. (2010) U.S. Pat. No. 7,811,352.
75. Halpern M, et al. (2015) Chapter Two-The use of biostimulants for enhancing nutrient uptake. Adv Agron 130:141-174.
76. Canellas L P, et al. (2015) Humic and fulvic acids as biostimulants in horticulture. Sci Hortic 196:15-27.
77. Robinson E C (1988) U.S. Pat. No. 4,743,287.
78. Kitten J (2000) U.S. Pat. No. 6,051,043.
79. Porubcan R S (2008) U.S. Pat. No. 7,442,224.
80. Yamashita T T (2000) U.S. Pat. No. 6,165,245.
81. Yamashita T T (2002) U.S. Pat. No. 6,475,258.
82. Taganov I, Tiainen M, & Paldanius A (2017) U.S. Pat. No. 9,738,567.
83. Wells G D (2014) U.S. Pat. No. 8,864,867.
84. Wells G D (2012) U.S. Pat. No. 8,197,572.
85. McCutcheon_Division (2017) McCutcheon's 2017 Emulsifiers& Detergents: International Edition (MC Publishing Company, Glen Rock, N.J.).
86. Paparella S, et al. (2015) Seed priming: state of the art and new perspectives. Plant Cell Rep 34(8):1281-1293.
87. Lutts S, et al. (2016) Seed priming: new comprehensive approaches for an old empirical technique. New Challenges in Seed Biology-Basic and Translational Research Driving Seed Technology, eds Araujo S & Balestrazzi A (InTech), pp 1-49.

1. An aqueous composition comprising:
a) one or more gamma amino acids selected from the group consisting of GABA, 4-aminovaleric acid and 5-aminovalenc acid;
b) one or more sulfonic acids selected from the group consisting of taurine (Tau), methylsulfamic acid, sulfoacetic acid hypotaurme, formamidinesulfimc acid, hydroxylamine-O-sulfonic acid, allylsulfonate, sodium 3-mercapto-1-propanesulfonate, sodium 2,3-dimercaptopropanesulfonate monohydrate, 1-propanesulfonic acid, 3-hydroxypropane-1-sulfonic acid, 1,3-propanedisulfonic acid, 3-hydroxypropane-1-sulfonic acid and 3-amino-1-propanesulfonic acid;
c) one or more macronutrients selected from the group consisting of calcium, sulfate, magnesium, phosphate, and potassium; and
d) one or more micronutrients selected from the group consisting of boron, iron, manganese, molybdate, and zinc.

2. The aqueous composition of claim 1 comprising between about 10 to about 1000 ppm of a gamma amino acid, between about 0.01 to about 1000 ppm of a sulfonic acid, between about 1 to about 1000 ppm of potassium selected from the group of potassium sulfates, about 1 to about 200 ppm of magnesium, about 2 to about 200 ppm of manganese, about 2 to about 200 ppm of zinc sulfate, about 1 to about 100 ppm of boron and about 0.01 to about 20 ppm of molybdate.

3. Use of the aqueous composition of claim 1 as a foliar spray on a plant or a crop to increase growth, yield or sugar content of the plant or crop.

4. Use of the aqueous composition of claim 1 for seed treatment or priming to increase growth, yield or tolerance to biotic or abiotic stresses of a plant or a crop grown from the treated or primed seed.

5. Use of the aqueous composition of claim 1 for soil application or soil drench to increase growth, yield or tolerance to biotic or abiotic stresses of a plant or a crop.

6. A method of increasing growth, yield or sugar content of a plant or a crop comprising spraying the aqueous composition of claim 1 on leaves of the plant or the crop and growing the sprayed plant or crop.

7. A method of increasing growth, yield or tolerance to biotic or abiotic stresses of a plant or a crop comprising treating or priming seed with the aqueous composition of claim 1 and growing a plant or a crop from the treated or primed seed.

8. A method of increasing growth, yield or tolerance to biotic or abiotic stresses of a plant or a crop comprising applying the aqueous composition of claim 1 to soil and growing a plant or crop in the soil.

9. The method of claim 8, wherein the aqueous composition is applied to the soil as a soil drench.
